(19) United States
(12) Patent Application Publication
(10) Pub. No.: US 2007/0151395 A1
(43) Pub. Date: Jul. 5, 2007

(54) Hot start lever mount

(76) Inventor: Robert L. Barnett, Costa Mesa, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/322,070

(22) Filed: Dec. 29, 2005

(51) Int. Cl. F16C 1/10

(52) U.S. Cl. 74/502.2

(57) ABSTRACT

Preferred embodiments of the present hot start lever mount permit the hot start control lever to be mounted in a selected one of a plurality of possible orientations on a vehicle handlebar. For example, the hot start lever may be mounted on either the right-hand side or left-hand side of the handlebar assembly, as desired by the individual user. In addition, preferred hot start levers may be mounted on either side of the handlebar axis, such as above or below the handlebar axis, or forward or rearward of the handlebar axis. In addition, preferably the hot start lever mount is incorporated with a standard control lever perch, such as a clutch lever perch or brake lever perch to efficiently utilize the available mounting space on the vehicle handlebar.

### BACKGROUND OF THE INVENTION

1. Field of the Invention

The present invention relates to control levers for handlebar-steered vehicles, such as motorcycles or all terrain vehicles (ATV's), for example. More particularly, the present invention relates to a handlebar mount for an auxiliary lever, such as a hot start lever, for example.

2. Description of the Related Art

Handlebar-steered vehicles, such as motorcycles and all-terrain vehicles, often employ a multitude of handlebar mounted control levers to operate various system components of the vehicle. For example, such vehicles may include both a clutch control lever and a brake control lever mounted on the handlebar of the vehicle. In addition, handgrips are mounted on opposing ends of the handlebar and provide a place for a rider of the vehicle to grasp the handlebars. In many instances, one of the handgrips, typically the right handgrip, incorporates a rotatable throttle assembly. Each of the control levers and throttle assembly typically include a control cable extending from the lever or throttle assembly to the specific vehicle system. As a result, space on the handlebar for additional vehicle control systems is often limited.

It has become common on certain vehicles to employ one of a variety of “hot start” systems. These systems operate to facilitate restarting of the vehicle when the engine is at or near a normal operating temperature. Many such hot start systems include a hot start control lever mounted to the handlebar of the vehicle and configured to actuate the vehicle's hot start system. The hot start lever is positioned at one of several fixed locations, either on the right hand side or left hand side of the handlebar and typically spaced in one direction from the handlebar axis (above, below, forward or rearward). The specific location of the hot start lever for any specific vehicle depends on the manufacturer of the vehicle or, if an aftermarket lever is used, the manufacturer of the hot start lever. However, an individual rider may prefer the hot start lever to be located in a position other than the position designated by the manufacturer of the vehicle or hot start lever.

### SUMMARY OF THE INVENTION

Preferred embodiments of the present hot start lever mount permit the hot start control lever to be mounted in any selected one of a plurality of available locations on a vehicle handlebar. For example, in the preferred arrangements, the hot start lever may be mounted on either the right-hand side or left-hand side of the handlebar assembly, as desired by the individual user. In addition, preferred hot start levers may be mounted on either side of the handlebar axis, such as above or below the handlebar axis, or forward or rearward of the handlebar axis. In addition, preferably the hot start lever mount is configured for use with, or is incorporated with, a standard control lever perch, such as a clutch lever perch or brake lever perch. Such an arrangement more efficiently utilizes the available mounting space on a vehicle handlebar in comparison to hot start levers that are separately mounted to the handlebar.

A preferred embodiment is a lever mount for actuating a control cable and including a housing and a wire movable within the housing. The lever mount includes a lever configured to actuate the control cable wire and a cable stop configured to abut an end portion of the control cable housing. The lever mount also includes a body configured to support the lever and the cable stop proximate a vehicle handlebar. The body is configured such that the lever and the cable stop are mountable to the body in a first arrangement wherein the lever is movable in a first direction to apply an actuation force to the control cable inner wire. In addition, the lever and the cable stop are mountable to the body in a second arrangement wherein the lever is movable in a second direction generally opposite the first direction to apply an actuation force to the control cable inner wire.

A preferred embodiment is a lever mount for actuating a control cable having a housing and a wire movable within the housing. The lever mount including a clamp member configured to cooperate with a control lever perch to surround a vehicle handlebar and secure the control lever perch in a desired angular orientation relative to the vehicle handlebar. The lever mount further includes a lever supported by the clamp member and configured to actuate the control cable wire. A cable stop is supported by the clamp member and configured to abut an end portion of the control cable housing. In a first arrangement of the lever, the cable stop and the control cable, movement of the lever in a first direction actuates the control cable wire. In a second arrangement of the lever, the cable stop and the control cable, movement of the lever in a second direction, generally opposite the first direction, actuates the control cable wire.

A preferred embodiment is a hot start lever mount kit. The kit includes a clamp member configured to cooperate with a control lever perch to surround a vehicle handlebar and secure the control lever perch in a desired angular orientation relative to the vehicle handlebar. A lever is configured to be supported by the clamp member and to actuate the control cable wire. A first cable stop is securable to the clamp member and configured to abut an end portion of the control cable housing. The first cable stop is configured to accommodate a first type of control cable housing. A second cable stop is securable to the clamp member and configured to abut an end portion of the control cable housing. The second cable stop is configured to accommodate a second type of control cable housing.

A preferred embodiment is a lever mount for actuating a control cable having a housing and a wire movable within the housing. The lever mount includes a lever configured to actuate the control cable wire. A cable stop is configured to abut an end portion of the control cable housing. A body is configured to support the lever and the cable stop proximate a vehicle handlebar. The lever mount also includes means for permitting the lever to be positioned on any one of a first side of a handlebar axis of the vehicle handlebar when the body is located on a right-hand side of the vehicle handlebar, a second side of the handlebar axis when the body is located on the right-hand side of the vehicle handlebar, the first side of the handlebar axis when the body is located on a left-hand side of the vehicle handlebar, and the second side of the handlebar axis when the body is located on the left-hand side of the vehicle handlebar.

### BRIEF DESCRIPTION OF THE DRAWINGS

These and other features, aspects, and advantages of the present invention are described below with reference to drawings of a preferred embodiment, which are intended to illustrate, but not to limit, the present invention. The drawings contain eight figures.

FIG. 1 is an elevational view of a motorcycle incorporating a preferred embodiment of the hot start lever mount.

FIG. 2 is a plan view of a left-hand side of the handlebar of the motorcycle of FIG. 1 viewed from above the handlebar and illustrating a portion of the hot start lever mount.

FIG. 3 is a plan view of the left-hand side of the handlebar and hot start lever mount of FIG. 2 viewed from behind the handlebar.

FIG. 4 is a plan view of the left-hand side of the handlebar and hot start lever mount of FIG. 2 viewed from below the handlebar.

FIG. 5 is an exploded, perspective view of the hot start lever mount of FIGS. 2-4, which includes a clamp member, a cable stop and a lever. An alternative cable stop to accommodate an alternative cable is shown in phantom.

FIG. 6 is a plan view of the clamp member of the hot start lever mount of FIGS. 2-5, illustrating a cable stop and lever mounting portion of the clamp member. In FIG. 6, the cable stop and the lever have been removed.

FIG. 7a illustrates the clamp member of FIG. 6 with the cable stop and lever mounted to the clamp member in a first arrangement. FIG. 7b illustrates the clamp member of FIG. 6 with the cable stop and lever mounted to the clamp member in a second arrangement.

FIGS. 8a-8d illustrate a portion of a handlebar with the hot start lever mount of FIGS. 2-5 in four possible alternative orientations. FIG. 8a illustrates the hot start lever mount arranged with the lever on a lower left side of the handlebar assembly.

FIG. 8b illustrates the hot start lever mount with the lever positioned on an upper left-hand side of the handlebar assembly. FIG. 8c illustrates the hot start lever mount configured with the lever on a lower right-hand side of the handlebar assembly. FIG. 8d illustrates the hot start lever mount configured with the lever positioned on an upper right-hand side of the handlebar assembly.

### DETAILED DESCRIPTION OF THE PREFERRED EMBODIMENT

Preferred embodiments of the present lever mount are configured for use with various types of handlebar-steered vehicles, such as motorcycles, all-terrain vehicles, and bicycles, for example. However, the present lever mount may also be adapted for use with other types of vehicles. Furthermore, although the present lever mount is described in the context of providing a mounting location for hot start lever, the lever mount may be useful with other types of control levers as well, such as engine choke levers, engine decompression levers, vehicle lights, turn signals or other system controls, for example.

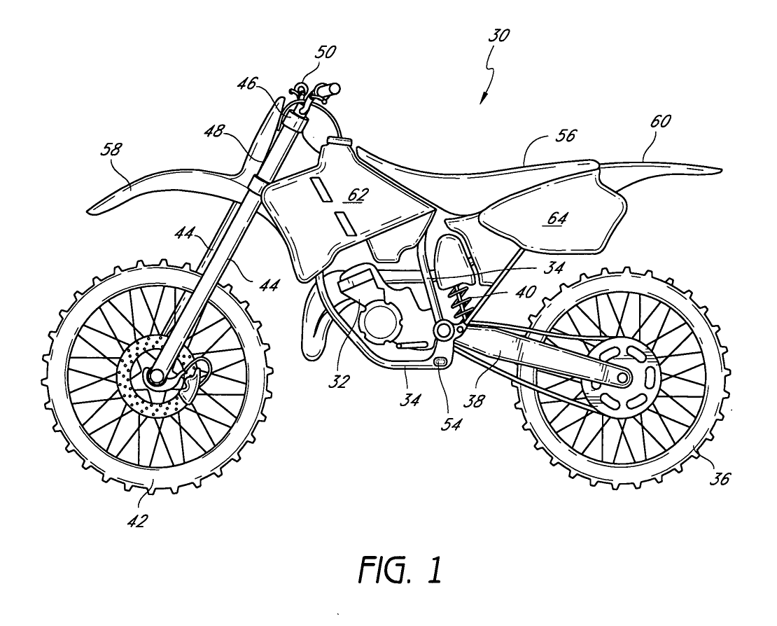

With reference to FIG. 1, an off-road motorcycle is referred to generally by the reference numeral 30. Preferably, the motorcycle 30 includes an internal combustion engine 32 mated to a manual transmission (not shown), which is mounted into a frame 34 of the motorcycle 30. A rear wheel 36 is connected to the frame 34 through a rear suspension system including a swing arm 38 and a rear shock absorber 40. Preferably, the rear wheel 36 is driven by the engine 32 through a chain and sprocket assembly. A front wheel 42 is connected to the frame 34 through a front suspension system, which in the illustrated embodiment is a telescoping fork 44. Upper and lower fork clamps 46, 48 couple the fork 44 to the frame 34 of the motorcycle 30. The fork clamps 46, 48 are connected to a steering stem (not shown) that is journaled for limited rotation about a steering axis defined by a head tube (not shown) of the frame 34.

A handlebar 50 preferably is connected to the upper fork clamp 46 to permit a rider of the motorcycle 30 to rotate the front wheel 42 and thereby steer the motorcycle 30. Preferably, each end of the handlebar includes a handgrip 52 for a rider of the motorcycle 30 to grasp. In addition, the handlebar 50 also provides a surface in which to mount a plurality of rider controls, preferably including a twist-type throttle assembly, an engine stop button, a brake lever and a clutch lever, as is described in greater detail below. Furthermore, preferably the motorcycle 30 includes a hot start lever, which is configured to actuate a hot start system of the motorcycle 30. Hot start systems are provided as standard equipment on various makes of motorcycles (as well as other vehicles) and, generally, are configured to facilitate restarting of the motorcycle engine 32 while the engine 32 is at or near its normal operating temperature. A typical layout of the handlebar-mounted controls places the throttle and brake lever on the right side of the handlebar 50 (from the perspective of a rider seated on the motorcycle 30) and the clutch lever 52 and engine stop button on the left side of the handlebar 50. The hot start lever may be located on either side of the handlebar 50, depending on the particular manufacturer of the motorcycle 30.

The motorcycle 30 also includes a pair of foot pegs 54, preferably mounted to a lower portion of each side of the frame 34, and which provide a platform for a rider of the motorcycle 30 to place his or her feet. An elongated, straddle-type seat 56 is provided to support a rider in a seated position. In addition, the motorcycle may include front and rear fenders 58, 60, a gas tank 62 and a pair of side panels 64. Such a construction is common for an off-road motorcycle. However, the illustrated motorcycle 30 is merely an exemplary environment of use for the present hot start lever mount. Accordingly, the motorcycle 30 may be constructed differently from that described herein. Furthermore, as discussed above, the lever mount described herein may be used with other types of vehicles as well.

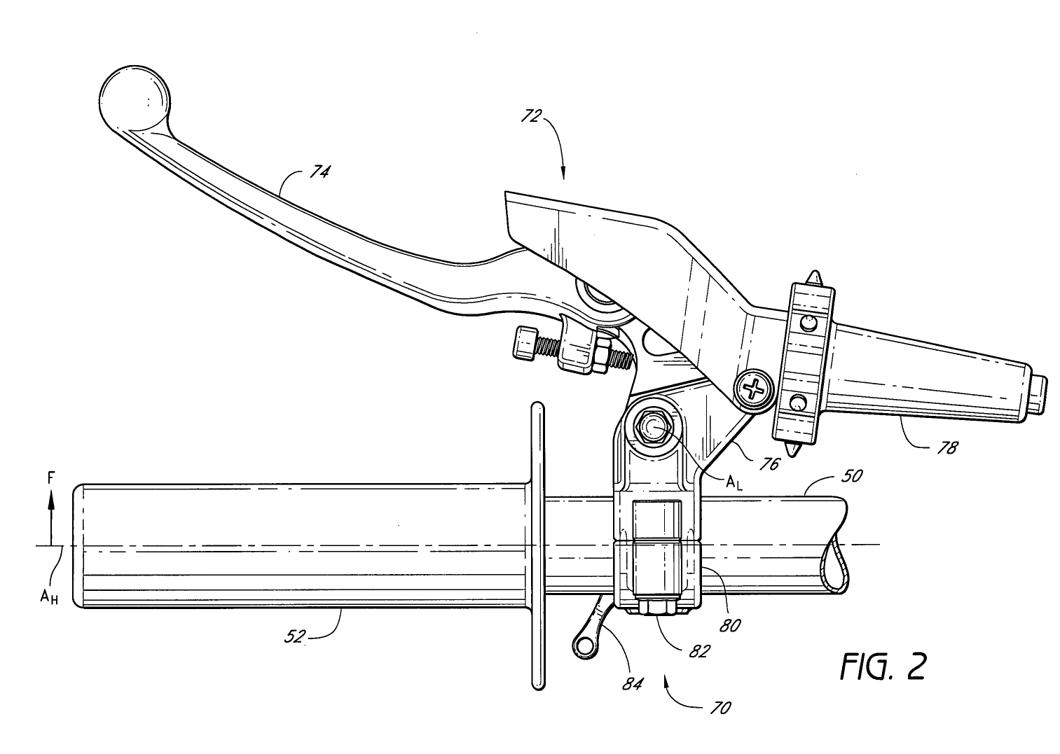

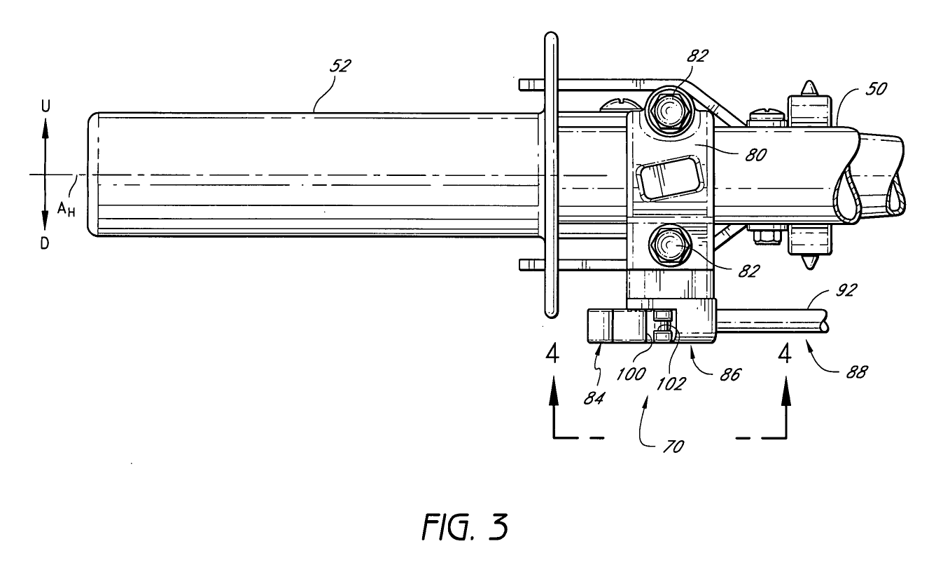

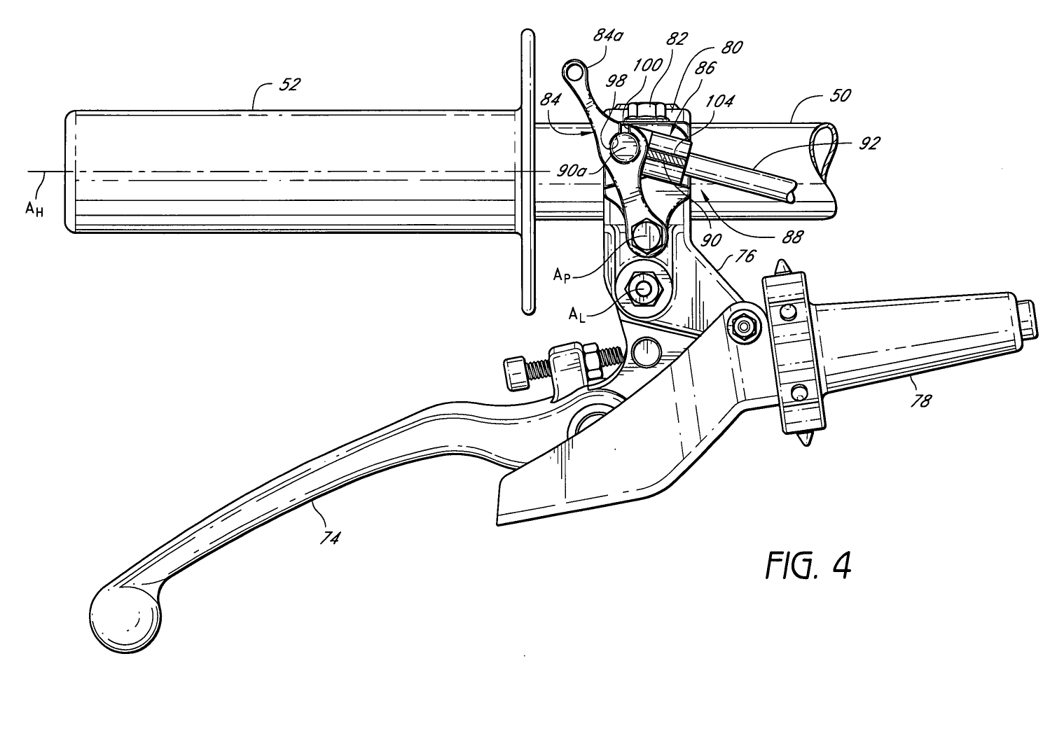

FIGS. 2-4 illustrate a left-hand side of the handlebar 50 including a preferred embodiment of the hot start lever mount, which is generally referred to by the reference numeral 70. FIG. 2 illustrates the left-hand side of the handlebar 50 as viewed from above. FIG. 3 is a view of the handlebar 50 from behind and FIG. 4 is a view of the handlebar 50 from below. The terms “above,” “behind,” and “below” and other relative terminology herein is used for convenience in describing the positions of various components, or direction of movement of various components, of the present hot start lever mount 70 as mounted on the motorcycle 30 of FIG. 1, which is in an upright orientation on a generally level surface.

In the illustrated arrangement, the hot start lever mount 70 is incorporated into a control lever of the motorcycle 30 and, specifically, a manual clutch control lever assembly 72. However, in other arrangements, the hot start lever mount may be incorporated into another control component, such as the front brake lever. In other arrangements, the lever mount 70 may be a stand-alone assembly that is mounted to the handlebar 50 separately from the clutch lever assembly 72, or other components of the motorcycle 30.

The illustrated clutch lever assembly 72 includes a lever 74 supported by a clutch lever perch 76 generally forward of an axis A_{H} of the handlebar 50, as illustrated by the arrow F in FIG. 2. The perch 76 supports the lever 74 for rotation about a lever axis A_{L}, which is generally perpendicular with the handlebar axis A_{H}. The lever 74 is configured to apply a pulling force to a clutch cable, which includes an inner wire and an outer housing (described in greater detail below). However, in other arrangements, the lever 74 may be configured to actuate a hydraulic piston of a hydraulic clutch system, as will be appreciated by one of the skill in the art. The clutch lever assembly 72 also includes an adjustment mechanism 78, which permits the adjustment of free play in the clutch cable (not shown). The illustrated adjustment mechanism 78 is a so-called “quick adjust” mechanism, which permits adjustment while riding the motorcycle 30. The adjustment mechanism 78 is rotatable relative to the lever 74 and perch 76 to adjust the tension (or free play) of the clutch cable and, preferably, includes a detent arrangement to inhibit unintentional movement of the adjustment mechanism 78.

The illustrated lever 74 is of a two-piece construction wherein a finger-grip portion of the lever is deflectable away from the handlebar 50 to avoid damage to the lever 74 in the event of a crash. A preferred construction of the lever 74 is described in greater detail in U.S. Pat. No. 6,393,936, which is assigned to the owner of the present application. The entirety of U.S. Pat. No. 6,393,936 is incorporated by reference herein and made a part of this specification.

The clutch lever assembly 72 also includes a clamp member 80 that cooperates with the perch 76 to substantially surround the handlebar 50. The clamp member 80 is connectable to the perch 76 such that the handlebar 50 may be clamped therebetween to secure the clutch lever assembly 72 in a desired angular position relative to an axis A_{H} of the handlebar 50. The clamp member 80 preferably is configured to be connectible to the perch 76 by a pair of fasteners, such as bolts 82. The perch 76 includes a pair of threaded apertures (not shown) configured to receive threaded shaft portions of the bolt 82. Accordingly, tightening of the bolts 82 moves the clamp member 80 towards the perch 76 to apply a clamping force to the handlebar 50. However, other suitable arrangements may also be used.

In the illustrated arrangement, a pair of bolts 82 secure the clamp member 80 to the perch 76. The bolts 82 straddle handlebar axis A_{H} with one bolt 82 being spaced vertically upward from the axis A_{H}, as illustrated by the arrow U in FIG. 3, and the other bolt 82 being spaced in a downward vertical direction from the handlebar axis Aₕ as illustrated by the arrow D in FIG. 3. However, in other arrangements the perch 76 and clamp member 80 may be configured such that the facing surfaces of the perch 76 and clamp 80 lie in a substantially horizontal plane such that the bolts 82 straddle the handlebar axis Aₕ on forward and rearward sides. Furthermore, the facing surfaces of the perch 76 and clamp 80 may lie in a plane that is offset from both the horizontal and vertical planes.

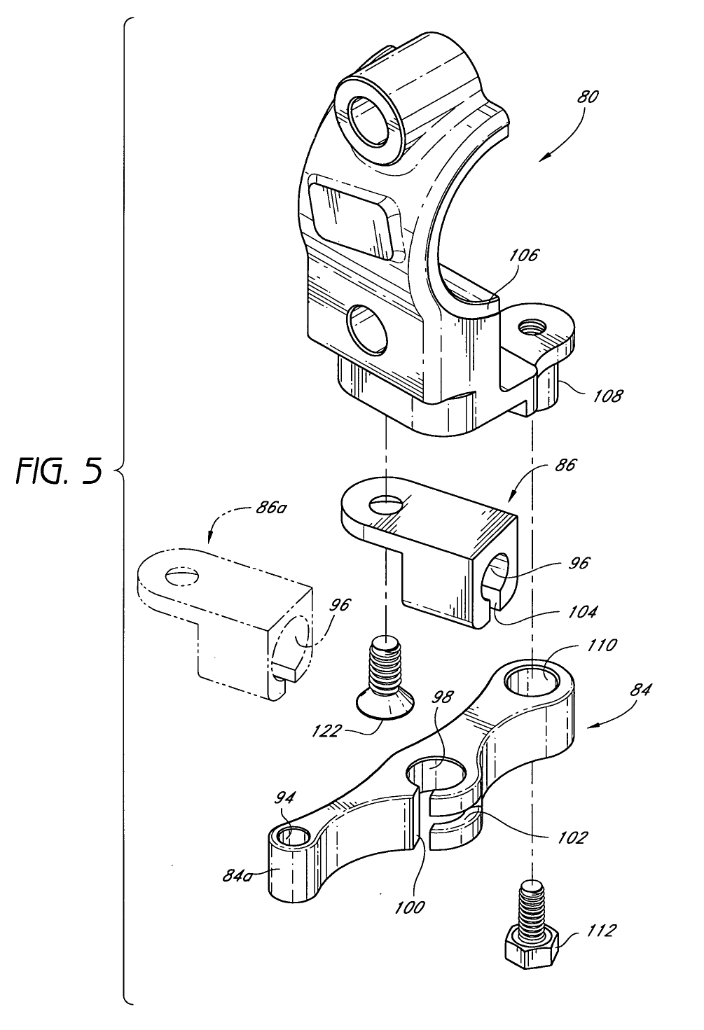

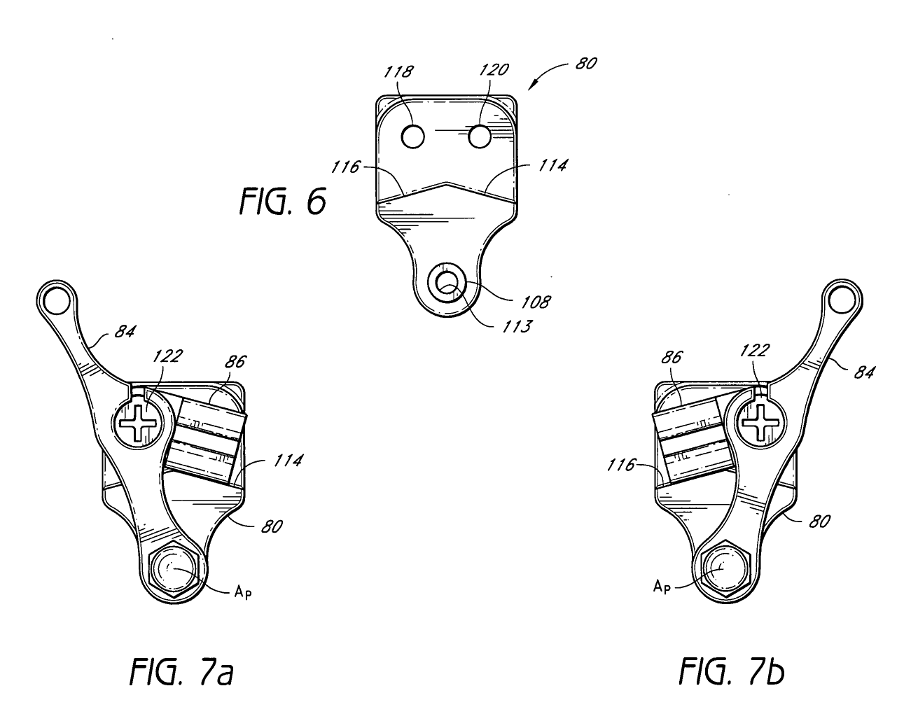

With additional reference to FIGS. 5 and 6, the illustrated lever mount 70 includes a lever 84 and a cable stop 86. The lever 84 and cable stop 86 are supported by the clamp member 80. Thus, in the illustrated arrangement, the clamp member 80 functions as a support body for the lever 84 and cable stop 86. However, as described above, in other arrangements, the lever 84 and cable stop 86 may be supported by a body that is securable to the handlebar 50 separately from the clutch lever assembly 72. Such a body may be comprised of first and second members that are securable to one another in a manner similar to the perch 76 and clamp member 80 to permit mounting of the body to the handlebar 50. The body may also be securable to the handlebar 50, or elsewhere on the motorcycle 30, by other suitable arrangements. Preferably, such a lever mount body supports the lever 84 in a location where it can be conveniently accessed by a rider of the motorcycle 30.

Illustrated in phantom in FIG. 5 is an additional cable stop 86a. The cable stop 86a is configured to be used in place of the cable stop 86 in certain circumstances. The cavity 96a of the cable stop 86a is configured to receive a different type of control cable 88 outer housing 92 than that of the cable stop 86. The cable stops 86 and 86a are configured to accommodate the two primary types of hot start control cables 88 currently used in connection with off-road motorcycles and are contemplated as being sold together so that the end user may select the appropriate cable stop 86, 86a. However, the cable stops 86, 86a may be sold separately or additional version(s) of cable stops 86 may also be provided.

As shown in FIGS. 2-4, the lever mount 70 is arranged such that the lever 84 is spaced from the handlebar axis A_{H} in a downward vertical direction, as illustrated by the arrow D of FIG. 3. In other words, the lever 84 is spaced below the handlebar axis A_{H}. However, preferably, the lever mount 70 is configured such that the position of the lever 84 may be selected from more than one possible positions. For example, in the illustrated arrangement, the lever mount 70 is configured such that the lever 84 may be positioned either above or below the handlebar axis A_{H}. Preferably, the lever mount 70 is also configured such that the lever 84 may be positioned on either the right-hand side or left-hand side of the handlebar 50.

The lever 84 is pivotal relative to the clamp member 80 about a pivot axis A_{P} (FIG. 4). Furthermore, the lever 84 is configured to actuate a hot start control cable 88, which includes an inner wire 90 and an outer housing 92. Specifically, the lever 84 is configured to receive a wire end (or barrel) 90a of the inner wire 90. The lever 84 includes an engagement portion 84a which is configured to be engaged by a rider of the motorcycle 30 to rotate the lever 84 about the pivot axis A_{P}. Preferably, the lever 84 is configured such that the rider will push or pull the lever 84 with his or her finger or thumb. In the illustrated arrangement, the engagement portion 84a of the lever 84 includes an aperture 94, which passes through the lever 84 in a direction substantially parallel to the aperture 98.

The cable stop 86 includes a surface that abuts an end of the cable housing 92 to stabilize the cable housing 92 in response to a pulling force applied to the inner wire 90 by the lever 84. Preferably, the cable stop 86 includes a generally cylindrical cavity 96 configured to receive and surround an end portion of the cable housing 92. An end surface of the cavity 96 abuts an end surface of the cable housing 92 to hold the housing 92 and permit the inner wire 90 to be moved relative to the housing 92 along with rotation of the lever 84.

In the illustrated arrangement, the wire end 90a of the inner wire 90 is received by an intermediate portion of the lever 84. Further, the pivot axis Aₚ of the lever 84 is located at one end of the lever 84 and the engagement surface 84a is located at an opposite end of the lever 84. Although such a construction is preferred, other arrangements of the lever 84 are possible.

To accommodate the wire end 90a, an intermediate portion of the lever 84 includes a generally cylindrical aperture 98, which passes through the lever 84 in a direction substantially parallel to the pivot axis A_{P}. A first slot 100 extends in a radial direction from the aperture 98 through an external surface of the lever 84. Another slot 102 extends from the slot 100 partially around the circumference of the aperture 98 on a side of the lever 84 facing the cable stop 86. Preferably, the slot 102 is located substantially at the center of the lever 84 (in a direction along the pivot axis A_{P}) and is oriented perpendicular to the longitudinal axis of the aperture 98. The slots 100, 102 permit the inner wire 90 to pass therethrough during assembly of the control cable 88 to the lever mount 70. Furthermore, the slot 102 accommodates the inner wire 90 during rotation of the lever 84 throughout its range of motion. Similarly, preferably the cable stop 86 includes a slot 104 which extends in a radial direction from the longitudinal axis of the recess 96 and through an outer surface of the cable stop 86. The slot 104 accommodates the inner wire 90 during assembly of the control cable 88 to the lever mount 70.

FIG. 5 illustrates the clamp member 80 removed from the perch 76. In addition, the lever 84 and cable stop 86 are shown separated from the clamp member 80. As illustrated in FIG. 5, the clamp member 80 may be configured to receive a relatively low friction sleeve 106 between the clamp member 80 and the handlebar 50. A similar sleeve (not shown) may be positioned between the perch 76 and the handlebar 50. The sleeves 106 provide sufficient friction, when the clamp member 80 is sufficiently tightened to the perch 76, such that the clutch lever assembly 72 is maintained in a desired rotational position relative to the handlebar 50 under normal operating circumstances. However, the sleeves 106 permit the clutch lever assembly 72 to rotate about the handlebar 50 in the event of a crash to inhibit damage to the clutch lever assembly 72. Other suitable arrangements may also be used, including a rotatable control lever perch as described in U.S. Pat. No. 6,892,603, which is assigned to the owner of the present application and is hereby incorporation by reference herein in its entirety and made a part of this specification.

In the illustrated arrangement, the clamp member 80 includes a post 108. Preferably, the lever 84 includes a corresponding aperture 110 which permits the lever 84 to be rotatably supported on the post 108. A fastener, such as a bolt 112 secures the lever 84 to the clamp member 80. Specifically, the bolt 112 includes a shaft portion with external threads which engage with internal threads of a cavity 113 within the post 108 such that the bolt 112 may be fastened to the clamp member 80.

FIG. 6 illustrates a surface of the clamp member 80 to which the cable stop 86 and lever 84 are secured. The surface of the clamp member 80 illustrated in FIG. 6 is the bottom surface of the clamp member 80, as the clamp member 80 is oriented in FIGS. 2-5. However, as discussed above, preferably the lever 84 and cable stop 86 may be secured to the clamp member 80 in multiple orientations to permit multiple possible positions of the lever 84 relative to the handlebar 50. Thus, in other orientations, the clamp member 80 may be positioned such that the surface illustrated in FIG. 6 is the top surface of the clamp member 80, for example.

In the illustrated arrangement, the clamp member 80 includes a first locater surface 114 and a second locater surface 116. The locater surfaces 114 and 116 are configured to contact the cable stop 86 to at least partially define first and second orientations of the cable stop 86 relative to the clamp member 80.

The clamp member 80 also includes a first threaded aperture 118 and a second threaded aperture 120. The threaded apertures 118 and 120 also preferably function to at least partially define the position of the cable stop 86 in a first orientation and a second orientation, respectively. Desirably, the first locater surface 114 cooperates with the first threaded aperture 118 to define a first orientation of the cable stop 86. Similarly, preferably the second locater surface 116 and the second aperture 120 cooperate to define a second orientation of the cable stop 86.

FIGS. 7a and 7b illustrate a first arrangement of the lever 84 and cable stop 86 and a second arrangement of the lever 84 and the cable stop 86, respectively. The first and second arrangements of the lever 84 and cable stop 86 are configured to pull the inner wire 90 of the control cable 88 in generally opposite directions relative to the clamp member 80 (and relative to the handlebar axis A_{H}) from one another.

FIG. 7a illustrates the cable stop 86 contacting the first locater surface 114 and with a threaded fastener 122 engaged with the first threaded aperture 118 to secure the cable stop 86 to the clamp member 80 in a first orientation. The lever 84 is secured to the post 108 with the aperture 98, and specifically the slot 102, facing the cable stop 86 such that the control cable 88 may be coupled to the lever 84 with the inner wire 90 extending through the slot 102. Rotation of the lever 84 away from the cable stop 86 actuates the control cable 88.

In FIG. 7b, the cable stop 86 is shown in a second orientation relative to the clamp member 80 in which the cable stop 86 contacts the second locater surface 116 and the threaded fastener 122 is engaged with the second threaded aperture 120 to secure the cable stop 86 to the clamp member 80. The lever 84 is rotated about its longitudinal axis 180° degrees such that the aperture 98, and the slot 102, faces the cable stop 86 in its second orientation. Accordingly, rotation of the lever 84 away from the cable stop 86 actuates the control cable 88. Rotation of the lever 84 about the pivot axis A_{P} to actuate the control cable 88 occurs in generally opposite directions between the arrangements of FIG. 7a and FIG. 7b. Thus, with such an arrangement, the lever 84 may be configured to rotate in an appropriate direction depending where the lever 84 is oriented relative to the handlebar 50, whether on the right-hand side or the left-hand side or above or below (or forward or rearward) of the handlebar axis A_{H}.

Although such an arrangement is preferred, other arrangements may be possible to permit the lever 84 to be mounted in multiple positions on the handlebar 50. For example, in one alternative arrangement, the cable stop 86 may be configured to receive the cable 88 in one of two possible orientations, without being reoriented relative to the clamp member 80. In such an arrangement, only the lever 84 need be flipped on the clamp member 80 to allow the direction of lever actuation to be changed. In a modification of such an arrangement, the lever 84 may be configured to receive the inner wire 90 of the control cable 88 from both sides of the aperture 98. Accordingly, with such an arrangement, the lever 84 may be simply rotated from one side of the cable stop 86 to the other side of the cable stop 86, or generally from the position of FIG. 7a to the position of FIG. 7b, without being removed from the clamp member 80 and flipped over.

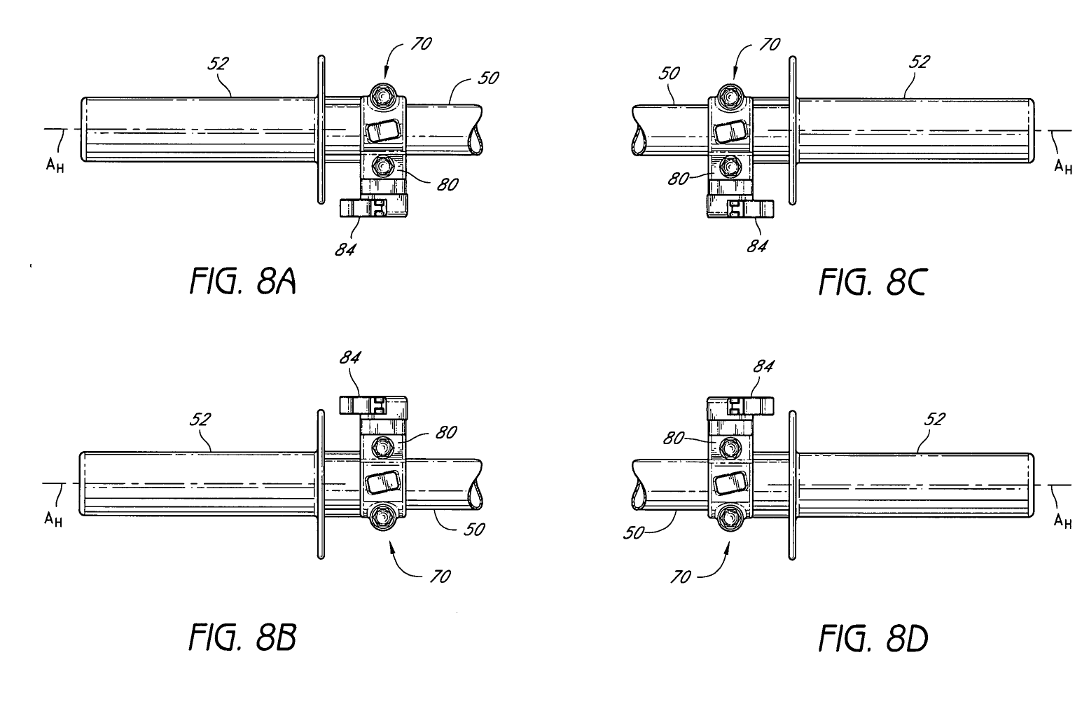

With reference to FIGS. 8a-8d, because of the lever 84 and cable stop 86 are configured to assume one of two arrangements, as illustrated in FIG. 7a and 7b, and because the clamp member 80 is configured to connect to the perch 76 with the lever 84 above or below the handlebar axis A_{H} (or forward or rearward of the handlebar axis Aₕ in some arrangements), the lever mount 70 may be configured for use in a plurality of different positions on the handlebar 50.

For example, as illustrated in FIG. 8a, the lever mount 70 is configured such that the lever 84 is positioned on the left-hand side of the handlebar 50 and below the handlebar axis A_{H}. This arrangement is illustrated in FIGS. 2-5 and involves the clamp member 80 being coupled to the clutch lever perch 76 with the lever mounting surface of the clamp member 80 positioned below the handlebar axis A_{H}. The lever 84 and cable stop 86 are mounted in the orientation shown in FIG. 7a.

In FIG. 8b, the lever mount 70 is configured such that the lever 84 is positioned on a left-hand side of the handlebar 50 and above the handlebar axis A_{H}. In this arrangement, the clamp member 80 is also coupled to the clutch lever perch 76 and the lever 84 and cable stop 86 are mounted in the orientation shown in FIG. 7b.

In FIG. 8c, the lever mount 70 is configured such that the lever 84 is located on a right-hand side of the handlebar 50 and below the handlebar axis A_{H}. In this arrangement, the clamp member 80 is coupled to a brake lever of the motorcycle 30 and the lever 84 and cable stop 86 are mounted in the orientation shown in FIG. 7a. Thus, preferably, the clutch lever assembly 72 and brake lever assembly employ the same bolt pattern for the fastening bolts 82 (FIGS. 2 and 3), which permits the clamp member 80 to fit on either the clutch lever perch 76 or the brake lever perch.

In FIG. 8d, the lever mount 70 is configured such that the lever 84 is located on the right-hand side of the handlebar 50 and above the handlebar axis A_{H}. In this arrangement, the clamp member 80 is coupled to a brake lever of the motorcycle 30 and the lever 84 and cable stop 86 are mounted in the orientation shown in FIG. 7b. As described above, when used in connection with some types of control lever assemblies 72, rather than being above or below the handlebar axis Aₕ, the lever 84 may be positioned forward or rearward of the handlebar axis A_{H}.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalence thereof. In particular, while the present hot start lever mount has been described in the context of particularly preferred embodiments, the skilled artisan will appreciate, in view of the present disclosure, that certain advantages, features, and aspects of the lever mount may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A lever mount for actuating a control cable having a housing and a wire movable within the housing, said lever mount comprising:
a lever configured to actuate the control cable wire;
a cable stop configured to abut an end portion of the control cable housing; and
a body configured to support said lever and said cable stop proximate a vehicle handlebar, said body configured such that said lever and said cable stop are mountable to said body in a first arrangement wherein said lever is movable in a first direction to apply an actuation force to the control cable inner wire and wherein said lever and said cable stop are mountable to said body in a second arrangement wherein said lever is movable in a second direction generally opposite said first direction to apply an actuation force to the control cable inner wire.

2. The lever mount of claim 1, wherein said body is configured to be mountable relative to the vehicle handlebar in a first orientation, such that said lever is positioned on a first side of an axis of the handlebar, and wherein said body is mountable to relative to the vehicle handlebar in a second orientation, such that said lever is positioned on a second side of the handlebar axis, opposite said first side.

3. The lever mount of claim 1, wherein said body includes a post configured to rotatably support said lever.

4. The lever mount of claim 1, wherein said lever is configured to receive an end of the control cable wire at a location intermediate an axis of rotation of said lever and a user contact surface of said lever.

5. The lever mount of claim 1, wherein said cable stop has a first orientation in said first arrangement and is rotated relative to said body to a second orientation in said second arrangement.

6. The lever mount of claim 5, wherein said cable stop includes a cavity configured to receive an end portion of the control cable housing, wherein said cavity generally faces a first direction along the axis of the vehicle handlebar in said first orientation and generally faces a second direction along the axis of the vehicle handlebar opposite the first direction in said second orientation.

7. The lever mount of claim 5, wherein said body comprises a first locator surface to at least partially define said first orientation of said cable stop and wherein said body comprises a second locator surface to at least partially define said second orientation of said cable stop.

8. The lever mount of claim 5, wherein said cable stop is secured to said body with a threaded fastener, said body including a first threaded aperture configured to receive said fastener and at least partially defining said first orientation of said cable stop and said body including a second threaded aperture configured to receive said fastener and at least partially defining said second orientation of said cable stop.

9. A lever mount for actuating a control cable having a housing and a wire movable within the housing, said lever mount comprising:
a clamp member configured to cooperate with a control lever perch to surround a vehicle handlebar and secure the control lever perch in a desired angular orientation relative to the vehicle handlebar;
a lever supported by the clamp member and configured to actuate the control cable wire;
a cable stop supported by the clamp member and configured to abut an end portion of the control cable housing;
wherein, in a first arrangement of said lever, said cable stop and the control cable, movement of said lever in a first direction actuates the control cable wire and
wherein, in a second arrangement of said lever, said cable stop and the control cable, movement of said lever in a second direction, generally opposite said first direction, actuates the control cable wire.

10. The lever mount of claim 9, wherein said clamp member is connectable to the control lever perch in a first orientation, wherein said lever is located on a first side of an axis of the vehicle handlebar, and a second orientation, wherein said lever is located on a second side of the axis of the vehicle handlebar.

11. The lever mount of claim 9, wherein a first side of said lever faces said clamp member in said first arrangement and wherein said lever is rotated such that a second side of said lever faces said clamp member in said second arrangement.

12. The lever mount of claim 11, wherein said clamp member includes a post configured to rotatably support said lever.

13. The lever mount of claim 9, wherein said lever is configured to receive an end of the control cable wire at a location intermediate an axis of rotation of said lever and a user contact surface of said lever.

14. The lever mount of claim 9, wherein said cable stop has a first orientation in said first arrangement and is rotated relative to said clamp member to a second orientation in said second arrangement.

15. The lever mount of claim 14, wherein said cable stop includes a cavity configured to receive an end portion of the control cable housing, wherein said cavity generally faces a first direction along the axis of the vehicle handlebar in said first orientation and generally faces a second direction along the axis of the vehicle handlebar opposite said first direction in said second orientation.

16. The lever mount of claim 14, wherein said clamp member comprises a first locator surface to at least partially define said first orientation of said cable stop and wherein said clamp member comprises a second locator surface to at least partially define said second orientation of said cable stop.

17. The lever mount of claim 16, wherein said cable stop is secured to said clamp member with a threaded fastener, said clamp member including a first threaded aperture configured to receive said fastener and at least partially defining said first orientation of said cable stop and said clamp member including a second threaded aperture configured to receive said fastener and at least partially defining said second orientation of said cable stop.

18. A hot start lever mount kit, comprising:
a clamp member configured to cooperate with a control lever perch to surround a vehicle handlebar and secure the control lever perch in a desired angular orientation relative to the vehicle handlebar;
a lever supported by the clamp member and configured to actuate the control cable wire;
a first cable stop securable to the clamp member and configured to abut an end portion of the control cable housing, said first cable stop configured to accommodate a first type of control cable housing; and
a second cable stop securable to the clamp member and configured to abut an end portion of the control cable housing, said second cable stop configured to accommodate a second type of control cable housing.

19. The lever mount kit of claim 18, additionally comprising the control lever perch.

20. A lever mount for actuating a control cable having a housing and a wire movable within the housing, said lever mount comprising:
a lever configured to actuate the control cable wire;
a cable stop configured to abut an end portion of the control cable housing;
a body configured to support said lever and said cable stop proximate a vehicle handlebar;
means for permitting said lever to be positioned on any one of a first side of a handlebar axis of the vehicle handlebar when said body is located on a right-hand side of the vehicle handlebar, a second side of the handlebar axis when said body is located on said right-hand side of the vehicle handlebar, said first side of the handlebar axis when said body is located on a left-hand side of the vehicle handlebar, and said second side of the handlebar axis when said body is located on said left-hand side of the vehicle handlebar.
